(19) United States
(12) Patent Application Publication
(10) Pub. No.: US 2006/0200592 A1
(43) Pub. Date: Sep. 7, 2006

(54) Configured printed circuit boards

(76) Inventors: Grady D. Lambert, Groton, MA (US); Ryan C. McDaniel, Hudson, MA (US)

Correspondence Address: PERKINS COIE LLP, P.O. BOX 2168, MENLO PARK, CA, 94026, US

(21) Appl. No.: 11/075,405

(22) Filed: Mar. 7, 2005

(51) Int. Cl. G06F 3/00

(52) U.S. Cl. 710/13

(57) ABSTRACT

A system, method and apparatus is provided for configured printed circuit boards. In one embodiment, the invention is an apparatus. The apparatus includes a FLASH memory module. The FLASH memory module include a printed circuit (p.c.) board. The FLASH memory module also includes a FLASH memory subsystem coupled to the p.c. board. The FLASH memory module further includes a connector attached to the p.c. board. The connector has a configuration corresponding to a voltage specification for the FLASH memory module. The connector is coupled through the p.c. board to the FLASH memory subsystem.

### CROSS-REFERENCE TO RELATED APPLICATION

Application Ser. No. ______, entitled “STACKABLE PRINTED CIRCUIT BOARDS”, having attorney docket number 54385-8003.US01 and filed on the same date as this application is hereby incorporated herein by reference as if fully set forth herein. Application Ser. No. ______, entitled “EXTENDED UNIVERSAL SERIAL BUS CONNECTIVITY”, having attorney docket number 54385-8004.US01 and filed on the same date as this application is also hereby incorporated herein by reference as if fully set forth herein.

### BACKGROUND

Printed circuit boards in general are well known and well understood. They are used for computer and other electrical components, have been designed to withstand severe environmental circumstances, and are the backbone from which much embedded computer technology springs. A printed circuit board thus has many potential applications.

As embedded computers become a more mature technology, cutting costs becomes more important. Moreover, providing the same functionality for a variety of applications becomes similarly important. Thus, one may expect to easily obtain a component or module which provides non-volatile memory. This would be true, whether one was looking for a 5 V power supply for a system, or a 3.3 V power supply for a system, for example. Moreover, one may expect to find essentially the same module regardless of power supply. This may also be true for other features, such as communications protocol, for example.

Thus, it may be useful to provide a printed circuit board which may be easily manufactured for a variety of environments. However, simply providing similar printed circuit boards may not be sufficient. For example, a printed circuit board with components designed for a USB bus standard 5 V power supply may simply fail to operate with a 3.3 V power supply. Similarly, and more catastrophically, components designed for a 2.5 or 3.3 V power supply may fail (and burn out for example), when exposed to a 5 V power supply. Thus, it may also be useful to provide a physically distinguishable indication of the configuration of a printed circuit board.

### SUMMARY

A system, method and apparatus is provided for configured printed circuit boards. In one embodiment, the invention is an apparatus. The apparatus includes a FLASH memory module. The FLASH memory module include a printed circuit (p.c.) board. The FLASH memory module also includes a FLASH memory subsystem coupled to the p.c. board. The FLASH memory module further includes a connector attached to the p.c. board. The connector has a configuration corresponding to a voltage specification for the FLASH memory module. The connector is coupled through the p.c. board to the FLASH memory subsystem.

The configuration of the connector may be determined by a keyed pin position of the connector in some embodiments. Furthermore, the configuration of the connector may be a first configuration corresponding to a supply voltage of 5 V. This first configuration may correspond to a first keyed pin position. Similarly, the configuration of the connector may be a second configuration corresponding to a supply voltage of 3.3 V or 3 V for example. This second configuration may correspond to a second keyed pin position. Additionally, the configuration of the connector may be determined based on an external physical configuration component.

In some embodiments, the voltage specification may be one of 5 V or 3.3 V. In other embodiments, the voltage specification may be one of 3.3 V or 2.5 V. In yet other embodiments, the voltage specification may include two of 5 V, 3.3 V, 3 V or 2.5 V.

In some embodiments, the apparatus includes a means for controlling the FLASH memory subsystem attached to the p.c. board and coupled to the FLASH memory subsystem. In some embodiments, the apparatus includes a FLASH controller attached to the p.c. board. The FLASH controller is coupled to the FLASH memory subsystem. The FLASH controller is also coupled to the connector. The FLASH controller is interposed between the connector and the FLASH memory subsystem. In some embodiments, the FLASH memory subsystem includes a single FLASH memory chip. In other embodiments, the FLASH memory subsystem includes multiple FLASH memory chips. Moreover, in some embodiments, a USB controller is attached to the p.c. board. The USB controller is coupled to the FLASH controller and to the connector. The USB controller is interposed between the connector and the FLASH controller.

In one embodiment, the invention is an apparatus. The apparatus includes a FLASH memory module capable of transferring data through a USB bus. The FLASH memory module include a printed circuit (p.c.) board. The FLASH memory module also includes a FLASH memory subsystem coupled to the p.c. board. The FLASH memory module further includes a connector attached to the p.c. board. The connector has a configuration corresponding to a voltage specification for the FLASH memory module. The connector is coupled through the p.c. board to the FLASH memory subsystem.

In another embodiment, the invention is a method. The method includes producing a printed circuit board having locations suitable for a connector and active circuitry. Additionally, the method includes determining if the printed circuit board should be configured for a higher or a lower incoming voltage. Moreover, the method includes populating the printed circuit board with a connector. The connector has a physical configuration specified for the incoming voltage. Furthermore, the method includes populating the printed circuit board with a component embodying the active circuitry. The method may further include the connector having an optional keyed pin, with a position of the keyed pin defining the physical configuration specified for the incoming voltage.

In still another embodiment, the invention is a method. The method includes producing a printed circuit board having locations suitable for a connector and active circuitry. Additionally, the method includes determining if the printed circuit board should be configured for a higher or a lower incoming voltage. Moreover, the method includes populating the printed circuit board with a connector. The connector has a physical configuration specified for the incoming voltage. Furthermore, the method includes populating the printed circuit board with a component embodying the active circuitry. The method may further include the connector having an optional keyed pin, with a position of the keyed pin defining the physical configuration specified for the incoming voltage. The printed circuit board has attached thereto components to communicate with a USB bus.

In yet another embodiment, the invention is an apparatus. The apparatus includes a printed circuit (p.c.) board module. The p.c. board module includes a p.c. board. The p.c. board module also includes an active circuitry component coupled to the p.c. board. The p.c. board module further includes a connector attached to the p.c. board. The connector has a configuration corresponding to a voltage specification for the p.c. board module. The connector is coupled through the p.c. board to the active circuitry. In some embodiments, the configuration of the connector is determined by a keyed pin position of the connector, with different pin position corresponding to different voltage specifications. In some embodiments, the connector has a pinout defined to receive signals specified by the Universal Serial Bus specification.

In another embodiment, the invention is an apparatus. The apparatus includes a printed circuit (p.c.) board module capable of communicating with a USB bus. The p.c. board module includes a p.c. board. The p.c. board module also includes an active circuitry component coupled to the p.c. board. The p.c. board module further includes a connector attached to the p.c. board. The connector has a configuration corresponding to a voltage specification for the p.c. board module. The connector is coupled through the p.c. board to the active circuitry. In some embodiments, the configuration of the connector is determined by a keyed pin position of the connector, with different pin position corresponding to different voltage specifications. In some embodiments, the connector has a pinout defined to receive signals specified by the Universal Serial Bus specification.

### BRIEF DESCRIPTION OF THE DRAWINGS

The present invention is illustrated in an exemplary manner by the accompanying drawings. The drawings should be understood as exemplary rather than limiting, as the scope of the invention is defined by the claims.

FIG. 1 illustrates an embodiment of a FLASH memory module.

FIG. 2 illustrates an embodiment of a printed circuit board with a connector and a physical standoff.

FIG. 3A illustrates an embodiment of a connector.

FIG. 3B illustrates an alternate embodiment of a connector.

FIG. 4 illustrates an embodiment of a system.

FIG. 5 illustrates an alternate embodiment of a system.

FIG. 6 illustrates an embodiment of a printed circuit board configured as a FLASH memory module.

FIG. 7A illustrates an embodiment of a method of operating that device or printed circuit board.

FIG. 7B illustrates an embodiment of an operation when voltage conversion is necessary.

FIG. 7C illustrates an embodiment of a process of operating a module where power supply conversion is not necessary.

FIG. 8 illustrates an embodiment of a method of assembling a device.

FIG. 9A illustrates a printed circuit board in yet another embodiment.

FIG. 9B illustrates a printed circuit board in still another embodiment.

### DETAILED DESCRIPTION

A system, method and apparatus is provided for configured printed circuit boards. The specific embodiments described in this document represent exemplary instances of the present invention, and are illustrative in nature rather than restrictive in terms of the scope of the present invention. The scope of the invention is defined by the claims.

In an embodiment, an apparatus is provided. The apparatus includes a FLASH memory module or similar printed circuit board-based system component. The component is specified to receive one or more voltages as an incoming voltage, such as from a Universal Serial Bus (USB) connection, for example. The component has an onboard connector designed to provide a communication path between the component and an associated system. The component is configured to accept only one input voltage, and this configuration is determinable from inspection of the connector, potentially in conjunction with an associated physical component. For example, the connector may be designed with a first physical configuration for a first incoming voltage, and with a second physical connection for a second incoming voltage.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments.

In one embodiment, the invention is an apparatus. The apparatus includes a FLASH memory module. The FLASH memory module include a printed circuit (p.c.) board. The FLASH memory module also includes a FLASH memory subsystem coupled to the p.c. board. The FLASH memory module further includes a connector attached to the p.c. board. The connector has a configuration corresponding to a voltage specification for the FLASH memory module. The connector is coupled through the p.c. board to the FLASH memory subsystem.

The configuration of the connector may be determined by a keyed pin position of the connector in some embodiments. Furthermore, the configuration of the connector may be a first configuration corresponding to a supply voltage of 5 V. This first configuration may correspond to a first keyed pin position. Similarly, the configuration of the connector may be a second configuration corresponding to a supply voltage of 3.3 V or 3 V for example. This second configuration may correspond to a second keyed pin position. Additionally, the configuration of the connector may be determined based on an external physical configuration component.

In some embodiments, the voltage specification may be one of 5 V or 3.3 V. In other embodiments, the voltage specification may be one of 3.3 V or 2.5 V. In yet other embodiments, the voltage specification may include two of 5 V, 3.3 V, 3 V or 2.5 V.

In some embodiments, the apparatus includes a means for controlling the FLASH memory subsystem attached to the p.c. board and coupled to the FLASH memory subsystem. In some embodiments, the apparatus includes a FLASH controller attached to the p.c. board. The FLASH controller is coupled to the FLASH memory subsystem. The FLASH controller is also coupled to the connector. The FLASH controller is interposed between the connector and the FLASH memory subsystem. In some embodiments, the FLASH memory subsystem includes a single FLASH memory chip. In other embodiments, the FLASH memory subsystem includes multiple FLASH memory chips. Moreover, in some embodiments, a USB controller is attached to the p.c. board. The USB controller is coupled to the FLASH controller and to the connector. The USB controller is interposed between the connector and the FLASH controller.

In one embodiment, the invention is an apparatus. The apparatus includes a FLASH memory module capable of transferring data through a USB bus. The FLASH memory module include a printed circuit (p.c.) board. The FLASH memory module also includes a FLASH memory subsystem coupled to the p.c. board. The FLASH memory module further includes a connector attached to the p.c. board. The connector has a configuration corresponding to a voltage specification for the FLASH memory module. The connector is coupled through the p.c. board to the FLASH memory subsystem.

In another embodiment, the invention is a method. The method includes producing a printed circuit board having locations suitable for a connector and active circuitry. Additionally, the method includes determining if the printed circuit board should be configured for a higher or a lower incoming voltage. Moreover, the method includes populating the printed circuit board with a connector. The connector has a physical configuration specified for the incoming voltage. Furthermore, the method includes populating the printed circuit board with a component embodying the active circuitry. The method may further include the connector having an optional keyed pin, with a position of the keyed pin defining the physical configuration specified for the incoming voltage.

In still another embodiment, the invention is a method. The method includes producing a printed circuit board having locations suitable for a connector and active circuitry. Additionally, the method includes determining if the printed circuit board should be configured for a higher or a lower incoming voltage. Moreover, the method includes populating the printed circuit board with a connector. The connector has a physical configuration specified for the incoming voltage. Furthermore, the method includes populating the printed circuit board with a component embodying the active circuitry. The method may further include the connector having an optional keyed pin, with a position of the keyed pin defining the physical configuration specified for the incoming voltage. The printed circuit board has attached thereto components to communicate with a USB bus.

In yet another embodiment, the invention is an apparatus. The apparatus includes a printed circuit (p.c.) board module. The p.c. board module includes a p.c. board. The p.c. board module also includes an active circuitry component coupled to the p.c. board. The p.c. board module further includes a connector attached to the p.c. board. The connector has a configuration corresponding to a voltage specification for the p.c. board module. The connector is coupled through the p.c. board to the active circuitry. In some embodiments, the configuration of the connector is determined by a keyed pin position of the connector, with different pin position corresponding to different voltage specifications. In some embodiments, the connector has a pinout defined to receive signals specified by the Universal Serial Bus specification.

In another embodiment, the invention is an apparatus. The apparatus includes a printed circuit (p.c.) board module capable of communicating with a USB bus. The p.c. board module includes a p.c. board. The p.c. board module also includes an active circuitry component coupled to the p.c. board. The p.c. board module further includes a connector attached to the p.c. board. The connector has a configuration corresponding to a voltage specification for the p.c. board module. The connector is coupled through the p.c. board to the active circuitry. In some embodiments, the configuration of the connector is determined by a keyed pin position of the connector, with different pin position corresponding to different voltage specifications. In some embodiments, the connector has a pinout defined to receive signals specified by the Universal Serial Bus specification.

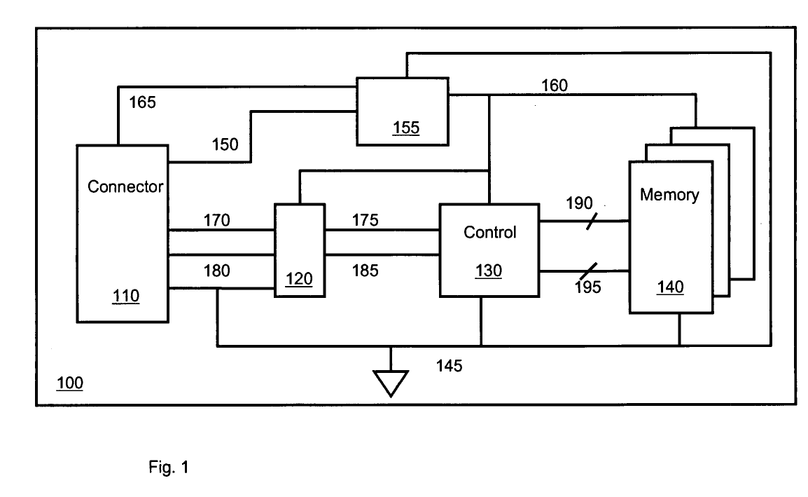

Turning to the figures, an illustration of a FLASH memory module or similar printed circuit board may be useful. Printed circuit board 100 illustrates an embodiment of a FLASH memory module in FIG. 1. Printed circuit board 100 includes a connector, a USB controller, a memory controller, FLASH memory and a voltage regulator. Connector 110 is a connector attached to printed circuit board 100 which is designed to receive signals from a connected printed circuit board through a mating connector. Connector 110, in one embodiment, is designed to receive USB standard signals through various pins and transmit those signals to the rest of printed circuit board 100. USB controller 120 is coupled to connector 110 through data signals 170 and 180. USB controller 120 is a standard USB controller which operates to receive USB signals and establish that those signals are in fact intended for the receiving device.

FLASH memory controller is coupled to USB controller 120 through data signals 175 and 185 as well. FLASH memory controller 130 controls a FLASH memory chip or set of FLASH memory chips. FLASH memory controller 130 is coupled to on-board FLASH memory 140 through a data bus 190 and an address/control bus 195. Thus FLASH memory controller 130 may control and sequence the operation of FLASH memory 140. FLASH memory 140 is either a single FLASH memory chip or packaged FLASH memory chip or a set of FLASH memory chips either packaged and attached or mounted directly to the board.

Also provided on the board is voltage regulator 155. Voltage regulator 155 receives bus voltage 165 and may also receive key 150 as signals and output voltage or Vboard 160 to the FLASH memory 140, FLASH memory controller 130 and USB controller 120, providing power to these components. If key 150 is provided as a signal, it may be tied to either Vbus, Vboard or ground, with the expectation that the signal would be driven in the opposite direction by a circuit on an associated printed circuit board. Voltage regulator 155 may be expected to regulate Vbus 165 to produce Vboard 160.

This may be a result of key signal 150 or it may be a result of a predefined configuration such as voltage regulator 155 automatically regulating Vbus 165 from 5 volts to a 3.3-volt Vboard 160 signal. Voltage regulator 155 may also be used to simply smooth out a received voltage or slightly step down a received voltage such that if Vbus 165 has a variation, Vboard 160 may be a smoother signal. Also illustrated is ground plane 170 which is coupled to each of the components on printed circuit board 100, thus providing a common ground plane.

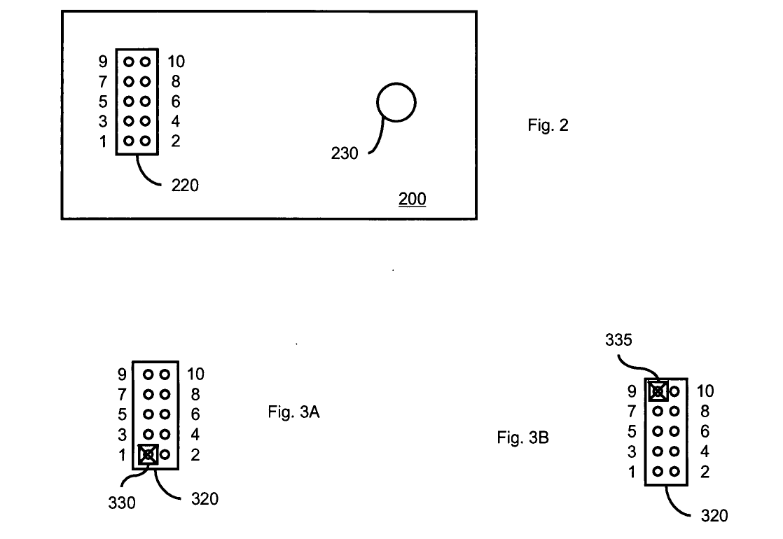

An embodiment of a printed circuit board illustrating a connector and a physical standoff is provided in FIG. 2. Printed circuit board 200 has connector 220 attached to it and also has standoff 230 attached to it as well. Connector 220, as illustrated, is a 10-pin connector. Standoff 230 is a purely structural member attached to printed circuit board 200 to provide physical stability when printed circuit board 200 is connected to another corresponding printed circuit board.

FIG. 3A illustrates a first embodiment of a connector. Connector 320 is a 10-pin connector such as connector 220 of FIG. 2. As is illustrated, a pin 1 in this instance is blocked off thereby creating key 330. In an alternate embodiment, in FIG. 3B, another embodiment of a connector is illustrated. Connector 320 is again illustrated but in this instance, rather than having key 330 present at pin 1, key 335 is present at pin 9. Thus the connector 320 as illustrated in the embodiments of FIGS. 3A and 3B may be used in alternate embodiments of a printed circuit board such as those of FIGS. 1 and 2 or other figures described herein.

For example, one embodiment may use connector 320 of FIG. 3A with key 330 present at pin 1 to signify a 5-volt on-board voltage for an associated printed circuit board, whereas another embodiment may use connector 320 with key 335 present at pin 9 to signify an on-board voltage of 3.3 volts. Thus by blocking one pin or another pin, one may provide a physical indication of the configuration of an associated printed circuit board and its components and thus avoid mistakenly placing the wrong board on or in the wrong system. Note that the presence of key 330 or 335 may not have an effect on actual operation of the circuitry of the printed circuit board—it may simply indicate the type of circuits present. Alternatively, one or the other key may allow a circuit on the printed circuit board to drive a configuration signal.

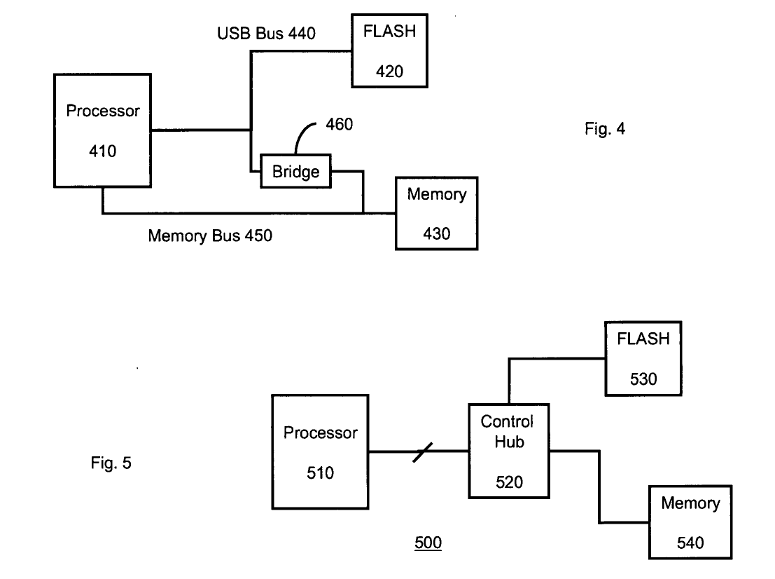

It may also be useful to illustrate or describe a system in which various printed circuit boards may be used, for example. FIG. 4 illustrates an embodiment of a system. System 400 includes a processor, memory, a FLASH memory module (such as printed circuit boards we have described previously for example) and a bus bridge.

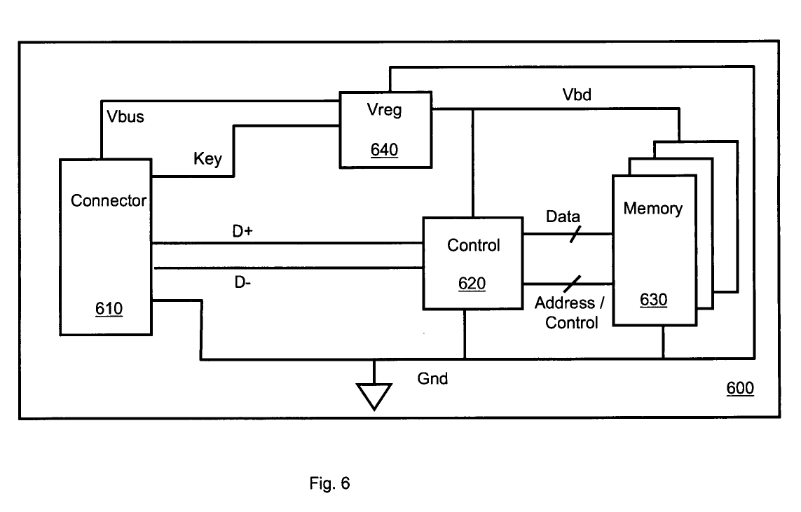

Processor 410 is a conventional processor such as a microprocessor or a digital signal processor or a similar device. Processor 410 is coupled through USB bus 440 to FLASH memory module 420. FLASH memory module 420 may be a memory module of various types such as the one illustrated in FIG. 1 or an embodiment such as may be found in FIG. 6 or other similar embodiments. FLASH memory module 420 may be implemented to use the same voltage which is used by processor 410 and system 400 or may be implemented to use a different presumably lower voltage on-board.

Memory 430 is on-board memory of system 400 and is coupled through memory bus 450 to processor 410. In some embodiments, to ease communication and the burden on processor 410, a bus bridge 460 may also be integrated between USB bus 440 and memory bus 450, allowing for essentially direct transfers from FLASH memory module 420 or some other USB device to memory 430 without requiring data to enter and exit processor 410.

Another embodiment of a system is presented in FIG. 5. System 500 includes a processor, a controller, a FLASH memory module and on-board memory. Processor 510 is coupled to controller 520 which acts as a front end or memory control hub, for example, for system 500. Controller 520 is coupled to FLASH memory module 530 and to on-board memory 540, allowing for communication between the various memory sources and processor 510. For example, controller 520 may be coupled through a USB bus to FLASH memory module 530. Thus processor 510 may operate controller 520 while allowing controller 520 to actually transfer data between FLASH memory module 530 and memory 540, for example.

Other embodiments of a FLASH memory module or similar printed circuit board may be used in various systems such as systems 400 and 500, for example. FIG. 6 illustrates an embodiment of a printed circuit board configured as a FLASH memory module. Printed circuit board 600 has attached to it a connector 610 for communication with other components, a controller 620, a FLASH memory 630 and a voltage regulator 640.

As illustrated, connector 620 may be used with a USB bus to receive a Vbus, data positive, data negative and ground signals, which may also be viewed as two signals and power and ground. Data positive and data negative signals are supplied to controller 620, which may be a combined FLASH and USB controller, for example. Vbus is provided to voltage regulator 640 which may be a voltage regulator suitable for simply regulating voltage or may also receive a key signal to determine whether it should regulate a voltage or step down and regulate a voltage, for example. Voltage regulator 640 provides board voltage Vboard, which is supplied to both controller 620 and to FLASH memory 630.

Also supplied to each of controller 620, FLASH memory 630 and voltage regulator 640 is a ground signal or a ground plane. FLASH memory 630 may be a single chip or a set of chips which may be packaged or mounted directly on printed circuit board 600. FLASH memory 630 is coupled to controller 620 through a data bus and an address and control bus. Thus controller 620 may operate FLASH memory 630 in an essentially parallel fashion, as most memory is operated while providing and receiving data in a serial fashion from a USB bus through connector 610. In an instance where a key is provided as a signal, voltage regulator 640 may control the output voltage based on the key and the input voltage. Alternatively, where a key is not provided as a signal, no key signal would be provided even though it is illustrated and voltage regulator 640 would be expected to simply regulate the voltage Vbus to provide a steady voltage Vboard whenever power was available. In such an instance, voltage regulator may be capable of reconfiguring itself for a buck or boost converter as appropriate.

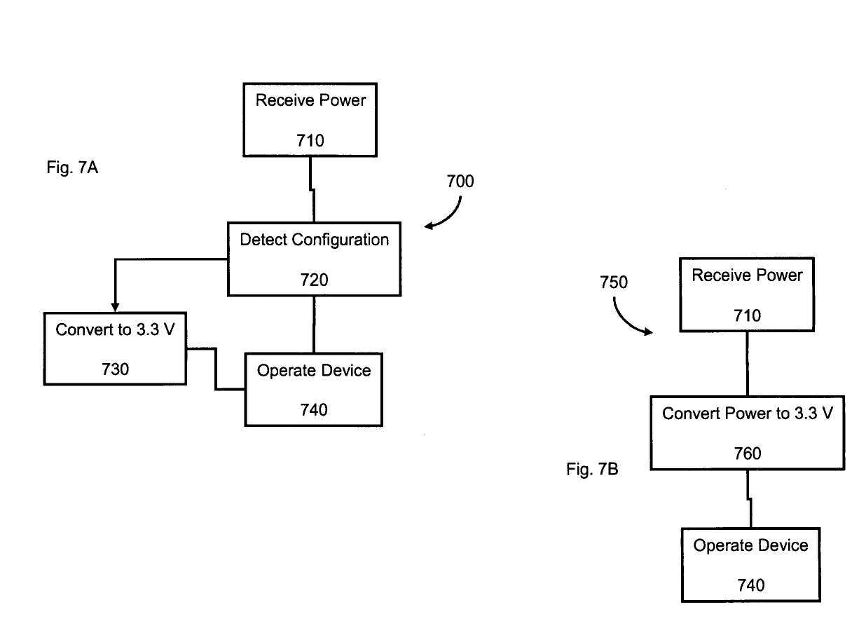

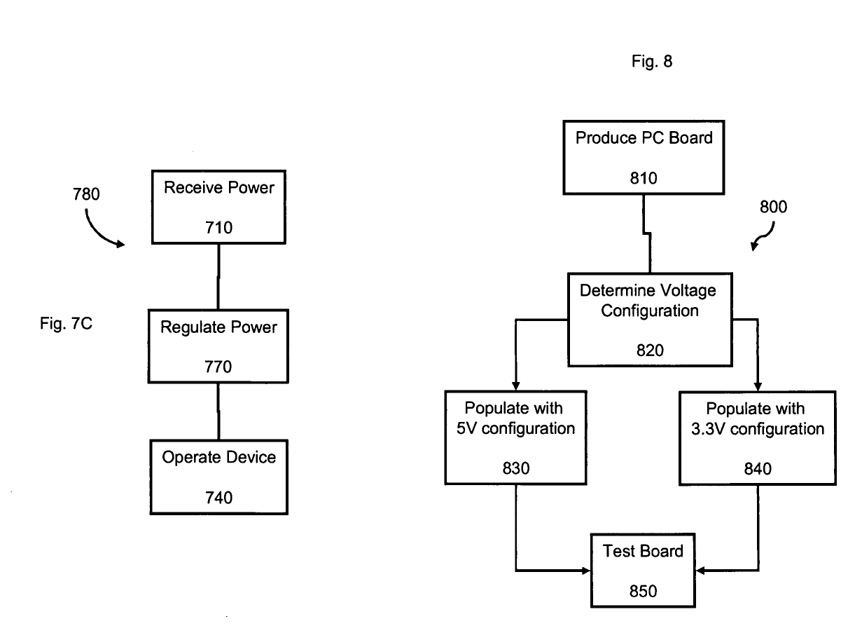

While various embodiments have been described in terms of apparatuses or systems, it may also be useful to understand a method or process involved. FIG. 7A illustrates an embodiment of a method of operating that device or printed circuit board. Process 700 and other processes of this document are implemented as a set of modules, which may be process modules or operations, software modules with associated functions or effects, hardware modules designed to fulfill the process operations, or some combination of the various types of modules, for example. The modules of process 700 and other processes described herein may be rearranged, such as in a parallel or serial fashion, and may be reordered, combined, or subdivided in various embodiments.

Process 700 includes receiving power, detecting a configuration, determining thereby whether to convert power or not and operating the device. Power is received at module 710. At module 720 a configuration is detected to determine whether 5-volt or 3.3-volt input is expected. At module 730 a 5-volt input is converted to a 3.3-volt power supply for on-board operation. At module 740 the device is operated using a 3.3-volt on-board power supply.

Alternate embodiments of operation may also be understood. FIG. 7B illustrates an embodiment of an operation when voltage conversion is necessary. Process 750 includes receiving power, converting power to a prescribed voltage output and operating the device. With regard to process 750, power is received at module 710. As the power is received at a 5-volt voltage level, power is then converted to a 3.3-volt voltage level at module 760. At module 740 the device is then operated using the 3.3-volt power supply.

FIG. 7C illustrates an embodiment of a process of operating a module where power supply conversion is not necessary. Process 780 includes receiving power, regulating that power and operating the device. At module 710 power is received. Power is regulated to smooth out any fluctuations at module 770. The device is then operated using the regulated power at module 740.

It may also be useful to understand how such devices may be assembled. FIG. 8 illustrates an embodiment of a method of assembling a device. Process 800 includes producing a printed circuit board, determining a voltage configuration, populating the printed circuit board based on that voltage configuration and testing the board.

The underlying printed circuit board is produced at module 810. A determination is made as to what voltage configuration the printed circuit board is to be operated at module 820. If a 5-volt operating voltage is expected, then at module 830 the printed circuit board module 810 is populated with a 5-volt configuration, such as including a voltage regulator which steps down the voltage to an on-board 3.3 voltage and associated active or passive components, for example. If the printed circuit board is to be operated at 3.3 volts, then at module 840 the printed circuit board is populated with a 3.3-volt configuration, such as including a voltage regulator which simply regulates a voltage. Regardless of configuration, at module 850 the printed circuit board as populated is then tested to determine appropriate functionality. Such a printed circuit board may then be provided to a customer or otherwise used.

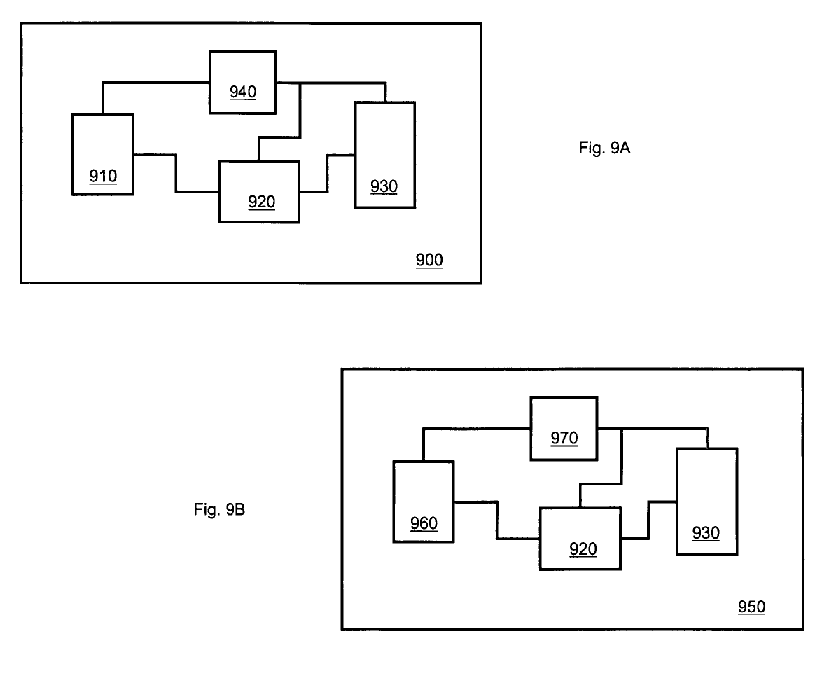

Alternate embodiments of printed circuit. boards may be assembled or operated according to the methods described and used within the systems described. FIG. 9A illustrates a printed circuit board in yet another embodiment. Printed circuit board 900 includes a connector in a first configuration, a controller memory and a voltage regulator. Connector 910 is in a first configuration as described, thus allowing connector 910 to, if properly utilized, only receive a first voltage such as 5 volts in a system which may support either 5 or 3.3 volts. As may be expected, when voltage specifications shift, one may at some point in the future use connector 910 in a system which allows for either 3.3 volts or 2.5 volts to receive a 3.3-volt power signal, for example.

Coupled to connector 910 is voltage regulator 940 which may receive the incoming voltage or power signal. Voltage regulator 940 may be expected to step that signal down to an on-board voltage such as 3.3 volts in a 5- or 3.3-volt system or 2.5 volts in a 3.3- or 2.5-volt system, for example. Voltage regulator 940 may be expected to provide power to controller 920 and memory 930, for example. Controller 920 may be a FLASH memory controller or similar non-volatile memory controller, for example. Memory 930 may be FLASH memory or some similar non-volatile memory, for example. Thus controller 920 may control FLASH memory 930 or memory 930 in conjunction with connector 910, which may be used for communication with the rest of an associated system. Moreover, controller 920 may be an integrated FLASH memory and USB bus controller, for example.

As may be expected, yet another alternate embodiment may also be produced. FIG. 9B illustrates an embodiment of a printed circuit board with a connector voltage regulator controller and memory. Connector 960 is configured to properly accept the voltage which will be used on-board and thus may, for example, have a key in a position which indicates such a configuration. The power pin from connector 960 may then be coupled to voltage regulator 970, which may be expected to regulate the incoming power to the same voltage or approximately the same voltage as is received from the bus or connector 960. Voltage regulator 970 may then be expected to supply power to FLASH controller or memory controller 920 and memory or FLASH memory 930. Thus printed circuit board 950 may be understood to be an embodiment wherein the printed circuit board is expected to accept a voltage which is approximately or actually the voltage operated by the voltage which the components on the board operate with. On the other hand, printed circuit board 900 may have a key in a different position in connector 910 such that it accepts a voltage higher than that with which the components operate with on the board.

Features and aspects of various embodiments may be integrated into other embodiments, and embodiments illustrated in this document may be implemented without all of the features or aspects illustrated or described.

One skilled in the art will appreciate that although specific examples and embodiments of the system and methods have been described for purposes of illustration, various modifications can be made without deviating from the spirit and scope of the present invention. For example, embodiments of the present invention may be applied to many different types of databases, systems and application programs. Moreover, features of one embodiment may be incorporated into other embodiments, even where those features are not described together in a single embodiment within the present document. Accordingly, the invention is described by the appended claims.

What is claimed is:

1. An apparatus, comprising:
A FLASH memory module capable of transferring data through a USB bus, including:
A printed circuit (p.c.) board;
A FLASH memory subsystem coupled to the p.c. board; and
A connector attached to the p.c. board, the connector having a configuration corresponding to a voltage specification for the FLASH memory module, the connector coupled through the p.c. board to the FLASH memory subsystem.

2. The apparatus of claim 1, wherein:
The configuration of the connector is determined by a keyed pin position of the connector.

3. The apparatus of claim 1, wherein:
The configuration of the connector is a first configuration corresponding to a supply voltage of 5 V.

4. The apparatus of claim 3, wherein:
The first configuration corresponds to a first keyed pin position.

5. The apparatus of claim 2, wherein:
The configuration of the connector is a second configuration corresponding to a supply voltage of 3.3 V.

6. The apparatus of claim 5, wherein:
The second configuration corresponds to a second keyed pin position.

7. The apparatus of claim 1, wherein:
The configuration of the connector is determined based on an external physical configuration component.

8. The apparatus of claim 1, wherein:
The voltage specification may be one of 5 V or 3.3 V.

9. The apparatus of claim 1, wherein:
The voltage specification may be one of 3.3 V or 2.5 V.

10. The apparatus of claim 1, wherein:
The voltage specification may include two of 5 V, 3.3 V, 3 V or 2.5 V.

11. The apparatus of claim 1, further comprising:
A means for controlling the FLASH memory subsystem attached to the p.c. board and coupled to the FLASH memory subsystem.

12. The apparatus of claim 1, further comprising:
A FLASH controller attached to the p.c. board, the FLASH controller coupled to the FLASH memory subsystem, the FLASH controller coupled to the connector, the FLASH controller interposed between the connector and the FLASH memory subsystem.

13. The apparatus of claim 1, wherein:
The FLASH memory subsystem includes a single FLASH memory chip.

14. The apparatus of claim 1, wherein:
The FLASH memory subsystem includes multiple FLASH memory chips.

15. The apparatus of claim 12, further comprising:
A USB controller attached to the p.c. board, the USB controller coupled to the FLASH controller, the USB controller coupled to the connector, the USB controller interposed between the connector and the FLASH controller.

16. A method, comprising:
Producing a printed circuit board having locations suitable for a connector and active circuitry;
Determining if the printed circuit board should be configured for a higher or a lower incoming voltage;
Populating the printed circuit board with a connector, the connector having a physical configuration specified for the incoming voltage;
and
populating the printed circuit board with a component embodying the active circuitry, the printed circuit board having attached thereto components to communicate with a USB bus.

17. The method of claim 16, wherein:
The connector has an optional keyed pin, with a position of the keyed pin defining the physical configuration specified for the incoming voltage.

18. An apparatus, comprising:
A printed circuit (p.c.) board module capable of communicating with a USB bus, including:
A p.c. board;
An active circuitry component coupled to the p.c. board;
and
A connector attached to the p.c. board, the connector having a configuration corresponding to a voltage specification for the p.c. board module, the connector coupled through the p.c. board to the active circuitry.

19. The apparatus of claim 18, wherein:
The configuration of the connector is determined by a keyed pin position of the connector, with different pin position corresponding to different voltage specifications.

20. The apparatus of claim 18, wherein:
The connector has a pinout defined to receive signals specified by the Universal Serial Bus specification.
